(19) United States
(12) Patent Application Publication
(10) Pub. No.: US 2026/0300215 A1
(43) Pub. Date: Oct. 1, 2026

(54) TRANSMISSION DEVICE FOR AN SPI COMMUNICATION

(71) Applicant: Robert Bosch GmbH, Stuttgart (DE)

(72) Inventors: Darko Rozic, Reutlingen / Betzingen (DE); Sai Gautam Janaki Premkumar, Sindelfingen (DE); Stefan Brucklacher, Wannweil (DE); Thomas Tietjen, Muensigen/Trailfingen (DE)

(21) Appl. No.: 19/477,220

(22) PCT Filed: Apr. 10, 2024
(86) PCT No.: PCT/EP2024/059739

§ 371 Date: Jan. 26, 2026

(30) Foreign Application Priority Data
Apr. 27, 2023 (DE) 10 2023 203 902.8

(51) Int. Cl. G06F 13/42; G06F 13/28

(52) U.S. Cl. CPC G06F 13/4282; G06F 13/28; G06F 2213/0002

(57) ABSTRACT

A transmission device for an SPI communication. The device includes: a control unit; a storage unit; a DMA controller; and an SPI module. The control unit is set up to configure an information technology connection between the DMA controller and the SPI module by virtue of a respectively corresponding DMA channel being assigned to a respective SPI transmission channel provided in the SPI module, to configure an information technology connection between the storage unit and the DMA controller by virtue of a respectively corresponding transmission buffer in the storage unit being assigned to each DMA channel that is assigned to an SPI transmission channel, to write a transmission dataset that is to be transmitted by means of the transmission device to a transmission buffer of the storage unit, and to initiate transmission of the transmission dataset with output of a transmission request to the SPI module.

### FIELD

The present invention relates to a transmission device for a Serial Peripheral Interface (SPI) communication.

### BACKGROUND INFORMATION

Some bus systems in the related art are used for data communication between different components and/or within respective components. Such bus systems are particularly advantageous in distributed systems such as vehicle systems.

One such bus system is the so-called SPI bus system, which represents a standard for a synchronous serial data bus. The SPI bus system is based on a so-called master-slave communication, in which a master component outputs a clock signal to synchronize connected slave components and initiates the respective communication processes using the slave components.

In the related art, when implementing an SPI communication, it is generally provided that a control unit (e.g. a CPU) initiates the respective SPI communication processes and controls the transfer of data to be transmitted and/or received via SPI.

Furthermore, so-called DMA (Direct Memory Access) controllers are described in the related art, which are set up to allow peripheral devices direct access to a system's main memory, so that data transfers are made possible substantially without burdening the control unit.

### SUMMARY

According to the present invention, a transmission device for a Serial Peripheral Interface (SPI) communication is provided. Such an SPI communication can be advantageously used, for example, between sensors and central control units for such sensors in a vehicle, without thereby limiting the proposed SPI communication to a vehicle-specific application. Such a vehicle is, for example, a road vehicle (e.g. motorcycle, car, van, truck), a rail vehicle, an aircraft/plane and/or a watercraft.

The transmission device according to the present invention comprises a control unit, a storage unit, a DMA (Direct Access) controller and an SPI (Serial Peripheral Interface) module.

The control unit is designed as, for example, an ASIC, FPGA, processor, CPU, digital signal processor, microcontroller, or the like. The control unit is set up to configure an information technology connection between the DMA controller and the SPI module by virtue of a respectively corresponding DMA channel being assigned to a respective SPI transmission channel provided in the SPI module. It should be noted that the configurations performed by the control unit described here and below may be predefined static configurations and/or configurations that can be dynamically adjusted at runtime.

The control unit is further set up to configure an information technology connection (static and/or dynamic) between the storage unit and the DMA controller by virtue of a respectively corresponding transmission buffer in the storage unit being assigned to each DMA channel that is assigned to an SPI transmission channel. It should be noted that the size and/or number of transmission buffers in the storage unit is not generally limited to specific values.

Furthermore, the control unit is set up to write a transmission dataset that is to be transmitted by means of the transmission device, which contains transmission data (i.e. user data) and control information corresponding to the transmission data for an SPI transmission (e.g. information about a number of transmission data, segmentation information for carrying out segmented data transmissions, addressing information that specifies a receiver of the data, etc.), to a transmission buffer of the storage unit provided for the transmission dataset, and to initiate transmission of the transmission dataset with output of a transmission request to the SPI module which identifies the transmission buffer used for this purpose.

According to an example embodiment of the present invention, the SPI module comprises an SPI controller and at least one SPI transmission buffer and is set up, in response to the transmission request of the control unit, to initiate an automatic transfer of the transmission dataset from the used transmission buffer of the storage unit to the SPI transmission buffer by addressing the DMA controller via the SPI transmission channel that corresponds to the transmission buffer of the storage unit identified by the transmission request. Based on the configured connections between the DMA controller and the storage unit, the DMA controller is then able to automatically transmit the transmission dataset to the corresponding SPI transmission buffer without involving the control unit.

The SPI module, which functions in particular as an SPI master, is further set up to output the transmission data written to the SPI transmission buffer by the DMA controller via an SPI bus that is connected to the SPI module via an information technology connection, wherein the control information corresponding to the transmission data is used by the SPI controller to carry out the SPI transmission. This means, for example, that addressing information from the control information is used to address a desired receiver (in particular an SPI slave) for the transmission data on the SPI bus.

The transmission device according to the present invention offers the particular advantage that, after being stored in the storage unit and the transmission process being initiated, transmission data or transmission datasets can be transmitted autonomously via the SPI bus without the control unit having to control the transmission. This relieves the control unit, allowing other operations to be performed by the control unit to be executed more quickly and/or allowing the use of a control unit with lower performance requirements, thereby, for example, reducing the cost of the transmission device.

A further advantage of the transmission device according to the present invention results from the fact that the simple scalability of the underlying architecture allows for particularly high flexibility, whereby, among other things, the number of transmission buffers of the storage unit and/or the size of respective transmission datasets and/or the number of SPI receivers, etc., can be flexibly adapted based on the configuration by the control unit.

Preferred embodiments and developments of the present invention are disclosed herein.

In an advantageous embodiment of the present invention, a number of SPI transmission buffers is less than a number of transmission buffers of the storage unit and in particular (ideally) the number of SPI transmission buffers corresponds to a value of one. This accordingly saves the required storage space for the SPI transmission buffer(s), which can, for example, contribute to a reduction in the required chip area and/or cost savings. Alternatively or additionally, the transmission buffer of the storage unit is set up to store a plurality of transmission data with at least one corresponding control information item in a respective transmission dataset. This advantageously reduces the required storage space in the storage unit and the data volume to be transferred from the storage unit to the SPI transmission buffer. Accordingly, transmissions of transmission data can be completed more quickly. This is particularly advantageous when multiple transmission data are to be transmitted to the same receiver.

In a further advantageous embodiment of the present invention, the DMA controller is set up to automatically segment a respective transmission dataset during transmission to a respectively corresponding SPI transmission buffer, taking into account a size of the SPI transmission buffer, and to automatically transmit individual data segments of the segmented transmission dataset successively to the SPI transmission buffer. This allows for particularly high flexibility of the transmission device according to the present invention, as the size of the respective transmission datasets can, in principle, be set arbitrarily. For this purpose, offset management is preferably provided for each DMA channel in the DMA controller, which manages the starting address of each subsequent data segment to be transmitted in the storage unit. It is understood that the next data segment to be transmitted will only be transmitted by the DMA controller to the SPI transmission buffer if the preceding data segment has been successfully transmitted on the SPI bus. For this purpose, a corresponding feedback mechanism from the SPI module to the DMA controller is advantageously provided.

Particularly advantageously, according to an example embodiment of the present invention, the SPI module further comprises an arbitration unit which is set up to evaluate prioritization information contained in the transmission requests of the control unit and/or specified by the configuration by the control unit in order to prioritize respective SPI data transmissions according to the prioritization information. Such prioritization makes it possible, firstly, to prioritize a plurality of untransmitted transmission datasets stored in the storage unit with regard to a transmission sequence, and/or to interrupt an ongoing transmission of a transmission dataset that has not yet been completely transmitted by transmitting a transmission dataset with a higher priority. In other words, it is possible to perform a prioritization-based switching between different transmission requests at different times, for example after a complete transmission of a respective transmission dataset and/or after a complete transmission of a respective transmission data packet within a transmission dataset, and/or after a complete transmission of transmission data from the SPI transmission buffer on the SPI bus. The latter offers the particular advantage of a particularly fast switching capability to higher-priority transmission requests and thus a particularly fast response time, which can be particularly advantageous in time-critical applications. This explicitly does not preclude the possibility that a priority-based switch to a different transmission request or a transmission dataset corresponding to the transmission request may occur at different times.

Preferably, the DMA controller is set up to interrupt an ongoing data transmission between the storage unit and the SPI module in response to a higher-priority data transmission requested by the arbitration unit (as described above, preferably whenever the corresponding SPI transmission buffer has been processed, i.e. transmitted) and to automatically resume the interrupted data transmission after the higher-priority data transmission has been completed. Such interruptions can also be carried out in a nested manner, for example if an ongoing data transmission is to be interrupted by a first higher-priority transmission and Subsequently by a second even higher-priority transmission, etc. For such priority-related interruptions, the offset management of the DMA controller for segmented data transmissions described above and/or a management different from this for the interruption of transmission processes can be used.

The control information contained in respective transmission datasets comprises, as described above, for example, addressing data for addressing respective receivers and/or information about the data volume to be transmitted in a transmission dataset and/or an SPI command and/or segmentation information for the respective transmission datasets, and/or optionally further information relating to the SPI protocol or the SPI transmission.

In a further advantageous embodiment of the present invention, the storage unit comprises at least one receive buffer, while the SPI module comprises at least one SPI receive buffer. In addition, the control unit is set up to configure the DMA controller and the SPI module by virtue of respectively corresponding DMA channels being assigned to respective SPI receive channels and by virtue of respectively corresponding receive buffers in the storage unit being assigned to respectively corresponding DMA channels. In this way, the transmission device according to the present invention is set up to receive data from respective receivers on the SPI bus independently of control by the control unit, thereby relieving the control unit, as with the data transmission described above. Advantageously, the control unit is actively informed (e.g. via an interrupt) upon the complete receipt of a receive dataset (which can be structured similarly to the transmission datasets). Alternatively or additionally, it is also possible for the control unit to check at regular intervals whether newly received data are available in the respective receive buffers in the storage unit, which can then be further processed by the control unit. It is understood that similar mechanisms may be provided to inform the control unit that a transmission dataset stored in the storage unit has been completely transmitted on the SPI bus, so that the control unit can use this information to write any further transmission data to be transmitted to the Storage unit in response.

Preferably, in each receive buffer of the storage unit a storage portion is provided for status information, which represents information relating to respectively corresponding receive data and which, together with the corresponding receive data, represents a respective receive dataset. The status information includes, for example, information about whether the reception of a receive dataset is complete and/or whether a receive dataset is error-free (e.g. through a checksum check), etc.

It is particularly advantageous for a number of SPI receive buffers to be less than a number of receive buffers in the storage unit, and particularly advantageous for their number to correspond to a value of one. This allows the advantages described above in connection with the SPI transmission buffer to also be achieved for the receive side of the transmission device. Alternatively or additionally, each receive buffer of the storage unit is set up to store a plurality of receive data with respectively corresponding status information in a respective receive dataset.

Further advantageously, the control unit of the transmission device according to the present invention is set up to perform and/or adjust the configuration of the DMA controller and/or the SPI module during an initialization phase and/or at runtime of the transmission device. In particular, the ability to adjust the configuration at runtime allows for a particularly high degree of flexibility in the transmission device according to the present invention.

Furthermore, it is possible that the control unit is set up to adjust prioritizations for respective transmission datasets at runtime. This can be advantageous, for example, if a vehicle's surroundings-sensing system, which uses, for instance, a transmission device according to the present invention for communication between a central control unit (SPI master) and a plurality of sensors (SPI slaves), needs to adjust data transmissions to and/or from certain sensors differently than previously configured due to current boundary conditions (e.g. to give higher priority to those sensors which can best detect a critical traffic situation).

### BRIEF DESCRIPTION OF THE DRAWING

An exemplary embodiment of the present invention is described in detail below with reference to the figure.

FIG. 1 is a schematic view of an example embodiment of a transmission device according to the present invention.

### DETAILED DESCRIPTION OF EXAMPLE EMBODIMENTS

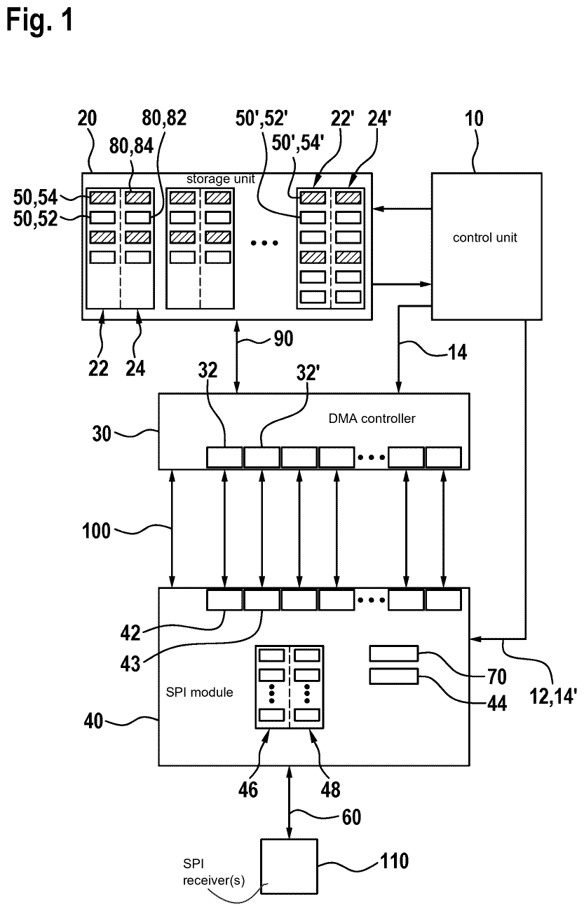

FIG. 1 is a schematic view of an embodiment of a transmission device according to the present invention, which is used, for example, for SPI-based data transmission between a plurality of ultrasonic sensors and an ultrasonic control unit in a vehicle. The transmission device comprises a control unit 10 configured as a CPU, a storage unit 20, a DMA controller 30 and an SPI module 40.

The control unit 10 is set up to transmit transmission datasets 50, 50′ to one or more SPI receivers 110 via an SPI bus 60 by writing the transmission datasets 50, 50′ to the respective transmission buffers 22, 22′ of the storage unit via an information technology connection.

It should be noted that respective components of the transmission device according to the present invention may be present multiple times (e.g., a plurality of transmission buffers 22, 22′, etc.) and that, for reasons of clarity, not all multiple embodiments of these components are provided with reference numerals, since their affiliation is easily apparent to a person skilled in the art.

Each transmission dataset 50, 50′ comprises control information 54, 54′ and at least one data packet representing user information to be transmitted, referred to here as transmission data 52, 52′. The transmission dataset 50 here comprises one data packet of transmission data 52, while the transmission dataset 50′ here comprises, for example, two data packets of transmission data 52′.

Analogous to the transmission buffers 22, 22′ and the transmission datasets 50, 50′, the storage unit 20 comprises a plurality of receive buffers 24, 24′, in each of which receive datasets 80 can be stored, wherein the receive datasets 80 represent data received by the SPI module 40 via the SPI bus 60. Each receive dataset 80 has at least one data packet which comprises user data, referred to here as receive data 82, and status information 84 relating to the receive data 82.

The control unit 10 is set up to configure an information technology connection between the DMA controller 30 and the SPI module 40 by virtue of a corresponding DMA channel 32 being assigned to a first SPI transmission channel 42 provided in the SPI module 40. The control unit 10 is also set up to configure an information technology connection between the storage unit 20 and the DMA controller 30 by virtue of a corresponding transmission buffer 22 in the storage unit 20 being assigned to the DMA channel 32. The configuration is performed by transmitting configuration data 14 to the DMA controller and configuration data 14′ to the SPI module 40. In a similar manner, additional SPI transmission channels can be linked to additional transmission buffers in the storage unit 20.

The control unit 10 is further set up to initiate a transmission of a transmission dataset 50 written to the storage unit 20 to the SPI receiver 110 by transmitting a transmission request 12 to an SPI controller 44 of the SPI module 40, which is provided for control within the SPI module 40, which identifies the transmission buffer 22 in the storage unit 20 that contains the transmission dataset 50 currently to be transmitted.

In response, the SPI controller 44 selects the SPI transmission channel 42 corresponding to the identifier of the transmission buffer 22 in order to select the DMA channel 32 linked to the transmission channel 42 by configuration. In response, the DMA controller 30 initiates a first data transmission 90, by means of which transmission datasets 50 contained in the transmission buffer 22 are read in individual data segments whose size is less than or equal to the size of the SPI transmission buffer 46 and written to the SPI transmission buffer 46 by means of a second data transmission 100 from the DMA controller 30.

The SPI controller 44 then initiates the transmission of the data present in the SPI transmission buffer 46 on the SPI bus 60.

Furthermore, the SPI module 40 comprises an SPI receive buffer 48 in which data received via the SPI bus 60 are stored. The control unit 10 is also set up to configure the DMA controller 30 and the SPI module 40 by virtue of a DMA channel 32′ being assigned to the SPI receive channel 43 and by virtue of a corresponding receive buffer 24 in the storage unit 20 being assigned to the DMA channel 32′. In a similar manner, additional SPI receive channels can be linked to additional receive buffers 24′ in the storage unit 20.

The receive buffers 24, 24′ are set up to receive data received in the SPI module 40 from the SPI bus 60 via the DMA controller 30 in the form of receive datasets 80, wherein each receive dataset 80 comprises at least one data packet representing respective receive data 82 and status information 84 corresponding to the receive data 82.

In addition, the SPI module 40 comprises an arbitration unit 70 which is set up to prioritize simultaneously pending transmission requests 12 or data transmissions resulting therefrom based on prioritization information provided via the transmission request 12, in accordance with the prioritization information. In a case in which a transmission request 12 arrives in the arbitration unit 70 with a higher priority than that of an already ongoing data transmission, the arbitration unit 70 initiates an interruption of the ongoing transmission via the SPI controller 44 as soon as the SPI transmission buffer 46 has been processed, i.e., transmitted. In response to the interrupted transmission, the transmission with the higher priority is then executed, and after this transmission, the previously interrupted transmission is automatically resumed by means of the DMA controller 30.

1-11. (canceled)

12. A transmission device for a Serial Peripheral Interface (SPI) communication, comprising:
a control unit;
a storage unit;
a Direct Memory Access (DMA) controller; and
an SPI module;
wherein:
the control unit is configured to:
configure an information technology connection between the DMA controller and the SPI module by virtue of a respectively corresponding DMA channel being assigned to a respective SPI transmission channel provided in the SPI module,
configure an information technology connection between the storage unit and the DMA controller by virtue of a respectively corresponding transmission buffer in the storage unit being assigned to each DMA channel that is assigned to an SPI transmission channel, and
write a transmission dataset that is to be transmitted by the transmission device, which contains transmission data and control information corresponding to the transmission data for an SPI transmission, to a transmission buffer of the storage unit provided for the transmission dataset, and initiate transmission of the transmission dataset with output of a transmission request to the SPI module, which identifies the transmission buffer to be used, and
the SPI module includes an SPI controller and at least one SPI transmission buffer and is configured to:
in response to the transmission request of the control unit, initiate an automatic transfer of the transmission dataset from the used transmission buffer of the storage unit to the SPI transmission buffer by addressing the DMA controller via the SPI transmission channel that corresponds to the transmission buffer of the storage unit identified by the transmission request, and
output the transmission data written to the SPI transmission buffer by the DMA controller via an SPI bus that is connected to the SPI module via an information technology connection, wherein the control information corresponding to the transmission data is used to carry out the transmission.

13. The transmission device according to claim 12, wherein:
a number of SPI transmission buffers is less than a number of transmission buffers of the storage unit and corresponds to a number of one, and/or
each transmission buffer of the storage unit is set up to store a plurality of transmission data with respectively corresponding control information in a respective transmission dataset.

14. The transmission device according to claim 12, wherein the DMA controller is configured to automatically segment a respective transmission dataset during transmission to a respectively corresponding SPI transmission buffer, taking into account a size of the SPI transmission buffer, and to automatically transmit individual data segments of the segmented transmission dataset successively to the SPI transmission buffer.

15. The transmission device according to claim 12, wherein the SPI module further includes an arbitration unit which is configured to evaluate prioritization information: (i) contained in transmission requests of the control unit and/or (ii) specified by the configuration by the control unit, in order to prioritize respective SPI data transmissions according to the prioritization information.

16. The transmission device according to claim 15, wherein the DMA controller is configured to:
interrupt an ongoing data transmission between the storage unit and the SPI module in response to a higher-priority data transmission requested by the arbitration unit, and
automatically resume the interrupted data transmission after the higher-priority data transmission has been completed.

17. The transmission device according to claim 12, wherein the control information includes:
addressing data, and/or
a data volume to be transmitted, and/or
an SPI command, and/or
segmentation information

18. The transmission device according to claim 12, wherein:
the storage unit includes at least one receive buffer,
the SPI module includes at least one SPI receive buffer,
the control unit is set up to configure the DMA controller and the SPI module by virtue of respectively corresponding DMA channels being assigned to respective SPI receive channels and by virtue of respectively corresponding receive buffers in the storage unit being assigned to respectively corresponding DMA channels.

19. The transmission device according to claim 18, wherein in each receive buffer of the storage unit, a storage portion is provided for status information, which represents information relating to respectively corresponding receive data and which, together with the corresponding receive data, represents a respective receive dataset.

20. The transmission device according to claim 18, wherein:
a number of SPI receive buffers is less than a number of receive buffers of the storage unit and corresponds to a number of one, and/or
each receive buffer of the storage unit is configured to store a plurality of receive datasets.

21. The transmission device according to claim 18, wherein the control unit is configured to perform and/or adjust a configuration of the DMA controller and/or the SPI module, during an initialization phase and/or at runtime of the transmission device.

22. The transmission device according to claim 21, wherein the control unit is configured to adjust prioritizations for respective transmission datasets at runtime.
